(19) United States
(12) Patent Application Publication
(10) Pub. No.: US 2025/0180337 A1
(43) Pub. Date: Jun. 5, 2025

(54) STABILIZED TARGET STAND AND SYSTEM

(71) Applicant: BITTERROOT OUTDOORS, LLC, SALT LAKE CITY, UT (US)

(72) Inventor: MATTHEW COLTON LIMPERT, SALT LAKE CITY, UT (US)

(21) Appl. No.: 19/053,189

(22) Filed: Feb. 13, 2025

Related U.S. Application Data
(63) Continuation-in-part of application No. 18/822,022, filed on Aug. 30, 2024.
(60) Provisional application No. 63/579,905, filed on Aug. 31, 2023.

(51) Int. Cl. F41J 1/10; F16M 11/24

(52) U.S. Cl. CPC F41J 1/10; F16M 11/24

(57) ABSTRACT

Systems and methods for stabilizing a target system that allows target shooters to practice their abilities in various environments and terrains. The target system may include a frame, a target insert, and a target. The target insert, with its various components, provides support and stability to a target. In order to secure the target, the target insert may be configured to fit into a keyhole located on the target. The target insert may include a key. The key may be made of foam or elastomer, providing friction to the target via the keyhole. When a projectile hits the target, the target system provides stability to help prevent the target from tipping over. Further, the target system is portable, lightweight, easy-to-use, and easy to set up in a myriad of conditions.

### CROSS-REFERENCE TO RELATED APPLICATIONS

This application is a continuation in part to U.S. patent application Ser. No. 18/822,022 filed Aug. 30, 2024, entitled “STABILIZED TARGET STAND AND SYSTEM”, which claims the benefit of U.S. Provisional Patent Application No. 63/579,905, filed on Aug. 31, 2023, entitled “Multi-Legged Target Stand, Target, and Connection Between Target and Stand,” the entire content of each application is incorporated herein by reference.

### BACKGROUND

Target practice is widely considered an important component of honing one's skills in projectile-based sports (e.g., archery, range shooting, and throwing implements such as knives and darts) just as it is for many other sports. Artificial targets have been used throughout human history for hunters or competitors to practice more efficiently. Conventional targets come in bag-style, foam block, and/or animal-shaped targets which provide an object at which a target shooter may aim his projectile. Target shooters often take these conventional targets and place them on an elevated surface (e.g., a table, hay bale, or tree stump) in order to experience a more realistic target height. This is done so that the target shooter may practice aiming at a target that would correlate to the height of, for example, an animal in the wild.

In general, conventional target systems fail to provide quick, lightweight, and easy-to-use systems for target shooters. Systems that are capable of being placed in rough terrain are often cumbersome, while systems that are portable are often not capable of sustaining an impact from a projectile without tipping over. Still other systems are far too heavy for target shooters to take while in the wild.

For example, some conventional systems rely on heavy metal stands that hang a bag from a hook. These systems are often too heavy for extended carrying or not capable of being positioned on rough terrain (e.g., mountain slopes, rock beds, in brush, etc.). Other systems rely on the user driving stakes into the ground to secure a target when being hit by a projectile. Another conventional system for target shooting is using an animal-shaped (e.g., deer, elk, or moose) foam target.

Unfortunately, in order to stabilize these animal-shaped foam targets, target shooters may have to drive large stakes into the ground to support the target as it is hit with a projectile. This mode of stabilization takes substantial effort and time to place the stakes in their proper positions. Similarly, target shooters may use a heavy metal stand from which the target shooter may hang a target bag. However, this system is cumbersome due to its weight and inability to be placed on rough terrain (e.g., mountain slopes, rocks, in brush, etc.). A related issue is that such conventional systems may be time-consuming to relocate. For example, relocating a target that has been staked into the ground may require the target shooter to remove the stakes, disassemble the target itself, find a new location, and then drive the stakes back into the ground at the new location with the reassembled target. Set up and takedown on rough terrain only tends to exacerbate the problem.

Furthermore, these conventional systems often do not provide a realistic height for a target. That is, the target is frequently at a lower height than an animal would be in the wild, thus failing to properly train the target shooter for real-life situations.

Accordingly, there are a number of problems with conventional systems that can be addressed.

### BRIEF SUMMARY

The present invention provides systems and apparatus corresponding to a stable, light-weight target stand that can be made to adjust to any given outdoor terrain while maintaining sufficient stability to withstand a force against a target, namely a projectile force. Exemplary projectiles include arrows or bullets.

For example, one embodiment comprises a target shooting stabilization stand (or stabilized target stand), comprising a plurality of stabilization legs, and a target insert removably coupled to the plurality of stabilization legs. The stand can further comprise a target, and optionally a keyhole. In additional embodiments, the target stand comprises a plurality of stabilization legs, such as, in some cases, four stabilization legs.

Additional or alternative embodiments comprise a target insert for a stabilized target stand. The target insert may include a tube for supporting sideways movement of the target placed on top of and/or around the target insert. The target insert can also include a plate for supporting a target placed on top of and/or around the target insert. In addition, the target insert can include a key for facilitating the placement of the target on top of and/or around the target insert. Furthermore, the target insert may include a top plate for securing the tube and the key.

Additional features and advantages will be set forth in the description which follows, and in part will be obvious from the description, or may be learned by practice. The features and advantages may be realized and obtained by means of the instruments and combinations particularly pointed out in the appended claims. These and other features will become more fully apparent from the following description and appended claims, or may be learned by the practice of the examples as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a perspective view of an example multi-legged target system (or “stabilized target stand”) as described herein;

FIG. 2 illustrates a cross-sectional view of an example stabilized target stand as described herein, wherein the legs of the stabilized target stand are in an expanded position;

FIG. 3 illustrates a cross-sectional view of an example stabilized target stand as described herein, wherein the legs of the stabilized target stand are in a closed position;

FIG. 4A illustrates a perspective view of an example target insert for a stabilized target stand without a key or top plate;

FIG. 4B illustrates a side view of an example target insert for use with a stabilized target stand without a key or top plate;

FIG. 5A illustrates a perspective view of an example tube for use with a stabilized target stand insert;

FIG. 5B illustrates a side view of an example tube for use with a stabilized target stand insert;

FIG. 5C illustrates a cross-sectional view of an example tube for use with a stabilized target stand insert;

FIG. 6A illustrates a perspective view of an example plate for use with a stabilized target stand insert;

FIG. 6B illustrates top view of an example plate for use with a stabilized target stand insert;

FIG. 6C illustrates side view of an example plate for use with a stabilized target stand insert;

FIG. 7A illustrates perspective view of an example key for use with a stabilized target stand insert;

FIG. 7B illustrates a side view of an example key for use with a stabilized target stand insert;

FIG. 7C illustrates a cross-sectional view of an example key for use with a stabilized target stand insert;

FIG. 8A illustrates a perspective view of an example top plate for use with a stabilized target stand insert;

FIG. 8B illustrates a top view of an example top plate for use with a stabilized target stand insert;

FIG. 8C illustrates a side view of an example top plate for use with a stabilized target stand insert;

FIG. 9A illustrates a perspective view of an example target for use with a stabilized target stand;

FIG. 9B illustrates a cross-sectional view of an example target for use with a stabilized target stand;

FIG. 9C illustrates a bottom view of an example target for use with a stabilized target stand;

FIG. 9D illustrates a side view of an example target for use with a stabilized target stand;

FIG. 10A illustrates a perspective view of an example mount for use with a stabilized target stand;

FIG. 10B illustrates a side view of an example mount for use with a stabilized target stand;

FIG. 10C illustrates a top view of an example mount for use with a stabilized target stand;

FIG. 10D illustrates a side view of an example mount platform for use with a stabilized target stand;

FIG. 11A illustrates a perspective view of an example mount connector for use with a stabilized target stand;

FIG. 11B illustrates a side view of an example mount connector for use with a stabilized target stand;

FIG. 11C illustrates a side view of an example mount connector for use with a stabilized target stand;

FIG. 12 illustrates a cross-sectional-exploded view of an example target system with a target, target insert, and frame; and

FIG. 13 illustrates various schematics in which a target is placed over keys of various shapes;

FIG. 14 illustrates a disassembled and assembled view of the stabilizing legs and attached target;

FIG. 15 illustrates perspective top and bottom views of a target shooting stand; and

FIG. 16 illustrates various perspective views of a squared and rounded key positioned atop the stabilizing legs in accordance with implementations of the present invention;

FIG. 17 illustrates a stabilized target stand as described herein; and

FIG. 18 illustrates a stabilized target stand interfacing with a target.

### DETAILED DESCRIPTION

In at least one implementation, the disclosed stabilized target stand, target system, and related sub-components can comprise a multi-legged frame capable of modular use in various environmental conditions and terrains. The multi-legged frame may comprise individually adjustable components. For example, each leg may be adjusted to a different height so that the target system may be placed in rugged terrain such as a ravine, along the side of a mountain, or along a rocky path. The feet of the multi-leg may be outfitted with various high-friction components (e.g., an elastomer) to provide stable ground-system connections.

Additionally, the target system may comprise a target insert. The target insert, as discussed in more detail below, may provide a modular support system that allows the use of multiple different targets with the same target system. For instance, the target insert may function with a foam block or an animal-shaped target that fits with the target insert. The target insert may connect with the frame via any number of securing means.

Having just described some of the various high-level features and benefits of the disclosed embodiments, attention will now be directed to the Figures, which illustrate various conceptual representations, architectures, methods, and/or supporting illustrations related to the disclosed embodiments.

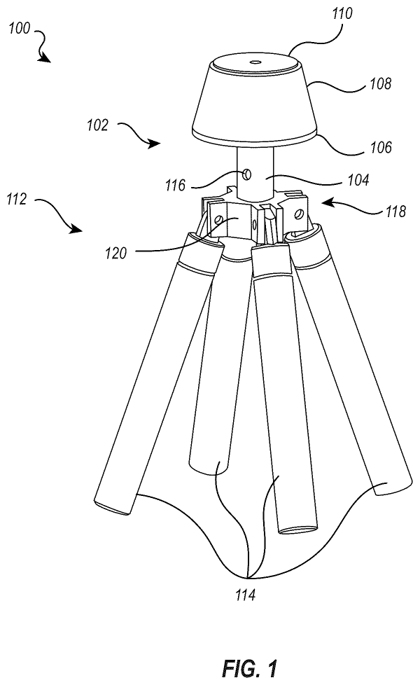

FIGS. 1-3 illustrate a perspective view and cross-sectional views, respectively, of an example multi-legged target stand 100 as described herein. The two main parts of the target stand 100 (or “stabilized target stand”) are the target insert 102 and the frame 112.

The frame 112 may include a plurality of stabilization legs 114 (e.g., 2 or more, 3 or more, or 4 or more legs, etc.) and a tube slot 104. The frame 112 may vary in weight from one pound (1 lb.) to 10 pounds (10 lbs.). The tube slot 104 may be designed to receive the tube 500 (i.e., if the tube 500 is substantially cylindrical, then the tube slot 104 may be shaped to fit flush with the cylindrical body of the tube 500). Tube slot 104 can pass through base 118, in some cases through an aperture, allowing it to rotate and adjust the height. In addition, set screw 120 may comprise a set screw to lock the tube slot (104) in place at the desired height and rotation. The length of tube slot 104 may be 8″-16″. In such a case, tube slot 104 can be fully adjustable in height relative to a base, and tube 500 may not be required as tube slot 104 can act in place of tube 500 directly and selectively coupling to target insert 102. The legs 114 may be individually, independently adjustable where, for example, depending on the terrain, a number (e.g., one or more) of the legs 114 may be fully extend whereas other legs (e.g., another one or more) may be fully retracted. However, the legs 114 may also be adjusted to any amount between full extension and full retraction on any of an individual or group basis. This high degree of adjustability may be accomplished by configuring each leg 114 with its own clamp system (or any other fastening system, such as pins, push pins, locks, screws, etc.). However, in some embodiments the number of legs 114 fitted with a fastening system may be fewer than the total number of legs 114 in the system. The adjustability of the legs 114 allows the target system 100 to be positioned on terrain where some conventional target systems may not be able to operate.

In some embodiments, the frame includes four legs 114 as shown in FIG. 1, rendering the target system 100 a quadpod target system. However, the number of legs 114 of the target system 100 is not limited to four. In other words, the target system 100 may have fewer than four legs 114 (e.g., three legs) or more than four legs (e.g., six legs).

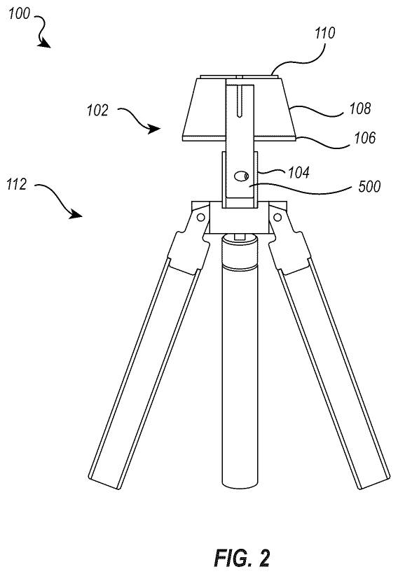

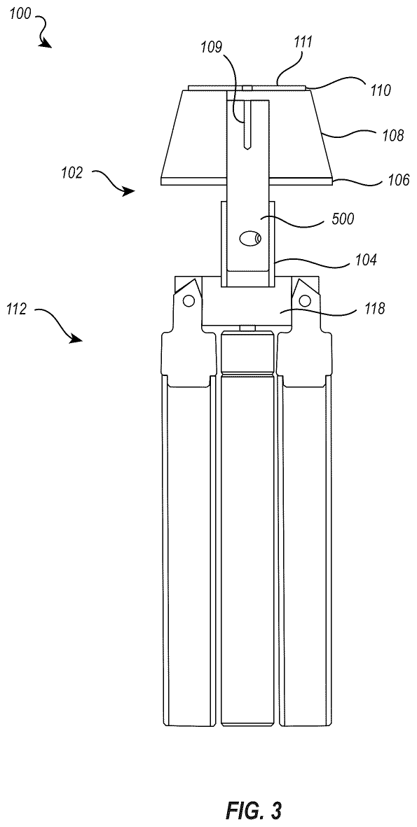

The legs 114 may be flared when in operation (FIGS. 1-2) or they may be closed (FIG. 3). In some embodiments, when (i) the target system 100 has four legs 114, (ii) it is in the flared configuration, and (iii) it has its legs 114 fully extended, the legs 114 of the target system 100 may measure about 16 inches (16″) from the leg 114 opposite to it. In other words, the diagonal of the square that is formed by the four legs 114 in a flared configuration may be about 16 inches (16″). Further, the height from the ground to the base of the target insert 102, when in the flared configuration, may measure about 16 inches (16″).

The legs 114 may be made of a lightweight metal or plastic material suitable for portability, such as aluminum. In some embodiments the legs 114 (as well as the rest of the target system 100) may be made of powder-coated steel to resist rust while adding durability.

The target insert 102 may include a tube 500 that may be welded (or otherwise secured) to a plate 106. On top of the plate 106, a key 108 may be positioned. On top of the key 108, a top plate 110 may be positioned. The top plate 110 may secure the components of the target insert 102 together by inserting a pin into a top hole 111 (FIGS. 2-3).

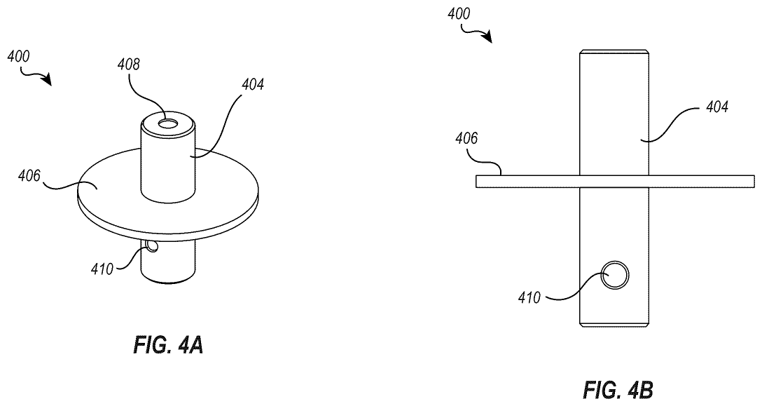

FIGS. 4A-4B illustrate a perspective view and a side view, respectively, of an example target insert 400 for a multi-legged target system 100 without a key 108 or top plate 110. The target insert 400 may comprise a tube 404, a plate 406, a top hole 408, and a side hole 410. The tube 404 may be of a continuous formation or segmented formation. In some embodiments, the tube 404 may be connected to the plate 406 by welding the tube 404 to the inside of the plate hole 614. However, other forms of securing the tube 404 to the plate 406 may achieve the same desired result, i.e., provide a support upon which the key 108 may be placed. The tube 404 may be welded to the plate 406 about halfway along the length of the tube 404 in order to provide a stable support for a target 900 above and stable connection to the frame 112 below. However, the weld does not have to be halfway along the tube 404.

The side hole 410 provides a connection point between the frame 112 and the target insert 400 (via the tube slot 104 and frame hole 116). In some embodiments, the side hole 410 may be about one-fourth inches (¼″) in radius. However, the side hole 410 may be larger or smaller than one-fourth inches (¼″). When placing the target insert 400 on the frame 112, a pin may be used to secure the target insert 400 to the frame 112 by aligning the side hole 410 and the frame hole 116 (FIG. 1).

As discussed below, a top pin 109 may be placed in the top hole 408, securing the various components (the tube 500, the key 108, and the top plate 110) of the target insert 400.

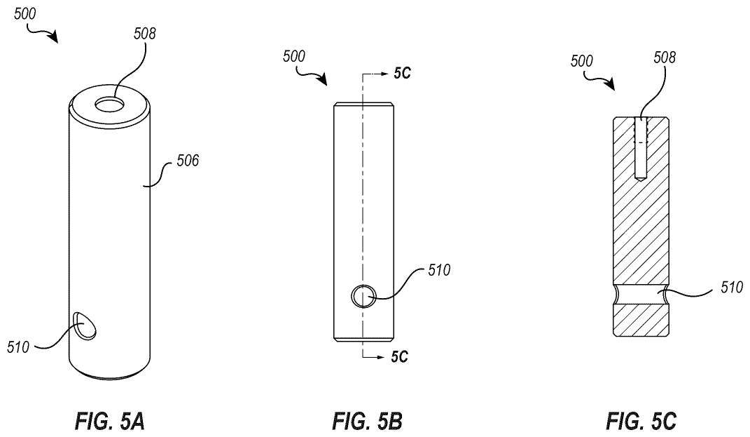

FIGS. 5A-5C illustrate a perspective view, a side view, and a cross-sectional view, respectively, of an example tube 500 for a target insert 400 without a key 108. As discussed above, the tube 500 may comprise a top hole 508 and a side hole 510. The top hole 508 may be about several inches deep (e.g., four inches (4″)) and about one-fourth of an inch (¼″) in radius. However, the depth of the top hole 508 may be greater than or less than about several inches deep. The width of the top hole 508 may also be greater than or less than about one-fourth inch (¼″). The length of the tube 500 may be about four inches (4″)″), in which case tube 500 may just become tube slot 104, and the size may very from 8″to 12″ in length with a diameter of about one inch (1″).

Although the tube 500 is shown as a cylinder (FIG. 5A), the tube 500 may be formed in any elongated shape (e.g., a rectangular prism) while still maintaining the function of securing the components of the target system 100. In addition to providing a platform upon which the target 900 may sit, the target insert 400, via the tube 500, also provides sideways support for the target system 100. In other words, when receiving a projectile, the tube 500, connected to the frame 112, provides support for the target 900. Furthermore, one will appreciate that the tube can be extended through the quad pod frame to be able to accommodate attachments, such as a backdrop or a paper holder. In this last case, tube 500 may not necessarily be required.

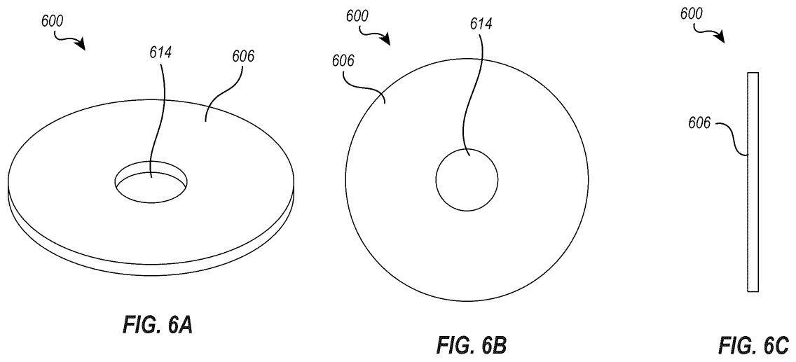

FIG. 6A-6C illustrates a perspective view, a top view, and a side view, respectively, of an example plate 600 for a target insert 400. The plate 600 may comprise a plate body 606 and plate hole 614. The tube 500, as discussed above, may be secured to the plate 600 (perhaps via a weld). The plate 600 may provide a platform upon which the key 108 may reside. The diameter of the plate hole 614 may be roughly the same measure as the diameter of the tube 500 such that the tube 500 may be securely fit in the plate hole 614. The plate body 606 may be rounded or it may have edges and corners. The plate 600 may be about four inches (4″) in diameter with a plate hole 614 that is about one inch (1″) in diameter and a height of about one-fifth inches (⅕″). The plate's shape may be square.

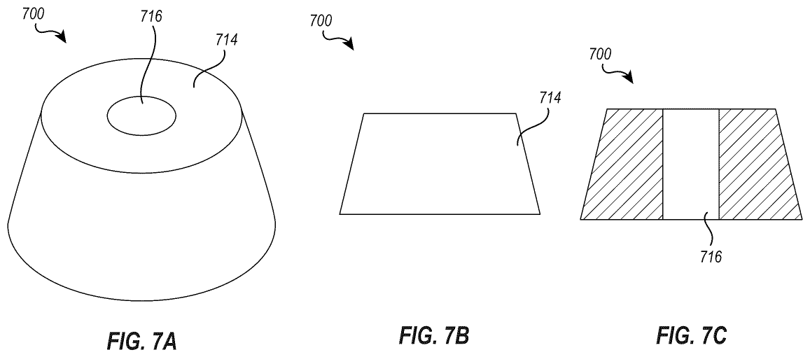

FIGS. 7A-7C illustrate a perspective view, a side view, and a cross-sectional view, respectively, of an example key 700 for a target insert 400. The key 700 may be made of foam and/or an elastomer. The key 700 provides support for a target 900 that may be placed on top of/around it and also ensures that the target 900 has a low chance of being tipped over upon receiving a projectile from a target shooter. Using a material, such as foam or elastomer, in the key's 108 construction allows the key to receive a projectile without breaking the projectile. For instance, a target shooter may release an arrow from a bow into the target. The arrow may also penetrate the key without breaking the tip of the arrow and thus preserve the arrow's ability to be used again.

The term “key” is used to define the elastomeric/foam member that sits atop the plate 600 and may take on many different shapes or sizes while maintaining the same function as the key 700 shown in FIG. 7A. For instance, In FIG. 7A, the key 700 is in a tapered cylindrical form (i.e., the diameter of the bottom section of the key 700 is larger than the diameter of the top section). The key 700 may be cylindrical or pyramid shaped. However, the key 700 may be a rectangular prism, a symmetrical cylinder (i.e., the diameter of the top and bottom are the same), a star prism, or any number of other shaped prisms that provide support for a target 900 positioned atop the key 700.

The key 700 may comprise a key body 714 and a key bore 716. The key bore 716 is a recess through which the tube 500 may be positioned and may span from the top of the key 700 to the bottom (FIG. 7C). The key 700 may range in height from two inches (2″) to 5 inches (5″) tall. The top of the key 700 may be about three inches (3″) in diameter (if a cylindrical pyramid) or about three inches by three inches (3″×3″) (if a rectangular pyramid), while the bottom of the key 700 may be about four inches (4″) in diameter (if a cylindrical pyramid) or about four inches by four inches (4″×4″) (if a rectangular pyramid). Additionally, the key bore 716 may be about one inch (1″) in diameter. Generally, the bottom of the key 700 is about flush with the plate 600 on the bottom and flush with the top plate 800 on the top (FIG. 1).

Further, the shape of the key bore 716 may generally resemble the shape of the tube 500 in order to facilitate a secure connection between the two. In some embodiments, the key bore 716 is shaped like a rectangular prism (or a prism with any number of sides). The key bore 716 may be centered through the key 700 or it may be offset from the center axis of the key 700.

When placing a target 900 on top of the target insert 400, the key 700 facilitates placement of and secures the target 900 to the target system 100. When the target 900 receives a projectile, the key 700 helps secure the target 900 to the target system 100. The key 700 also dissuades the target 900 from tipping over when the target 900 receives a projectile (not shown).

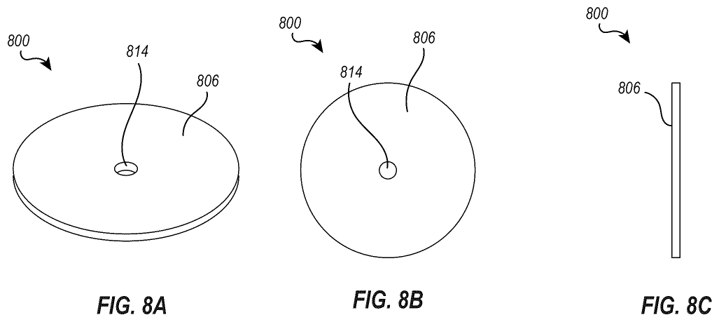

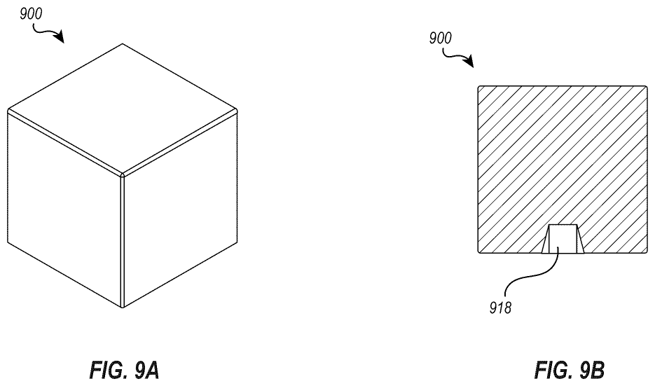

FIGS. 8A-8C illustrate a perspective view, a top view, and a side view, respectively, of an example top plate 800 for a target insert 400. The top plate 800 may be of circular design (FIGS. 8A-8B) but may be of any shape. In some embodiments, the top plate fits flush with the key 700 (FIG. 1) such that the top plate 800 and the key 700 form a continuous-seeming surface. When in a circular configuration, the top plate 800 may be about two and three-fourths inches (4″) in diameter, while the top late hole 814 may be about one-fourth inches (¼″) in diameter. The top plate hole 814 may be aligned with the center axis (not shown) (the axis that, when viewing FIG. 8B, runs in and out of the page through the center of the top plate body 806) of the top plate 800 or it may not be aligned with the center axis.

The top plate 800 may aid in securing the components of the target insert 400 by driving a top pin 109 through the top plate hole 814 (FIGS. 2-3). The top pin 109 may about equal in length to the top hole 508 (FIG. 5C) such that when the target insert 400 is assembled, the top pin 109 connects the top plate 800, the key 700, and the tube 500. This connection may ensure that the pieces of the target insert 400 remain assembled even when the target system 100 receives a projectile. The top pin 109 may be a variety of different fasteners (e.g., bolts, pins, screws, etc.) while maintaining the desired functionality.

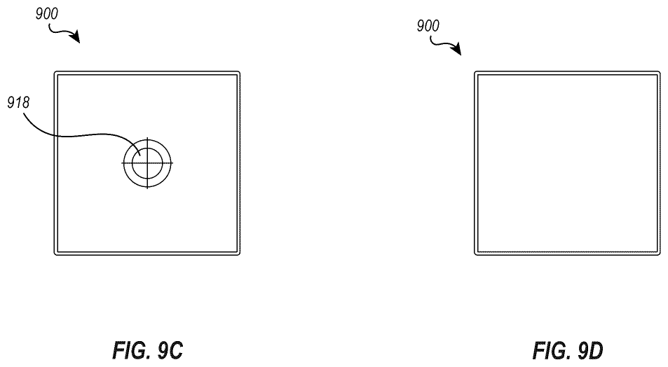

FIG. 9A-9D illustrate a perspective view, a cross-sectional view, a bottom view, and a side view, respectively, of an example target 900 for a multi-legged target system 100. The target 900 may be a durable cubic foam or elastomeric block. The target 900, in a cubic configuration, may be about sixteen inches by sixteen inches by sixteen inches (16″×16″×16″). Preferably target 900 is (14″×14″×14″). Target 900, however, can range in sizes, for example by having side lengths of six inches (6″) to twenty inches (20″). In some embodiments, the target system 100, when measured in a flared configuration with a cubic target 900, may measure about thirty-two inches (32″) from the ground to the top of the target 900. However, the target 900 may be of nearly any shape and size (i.e., not just a cube). With the varied size dimensions of target 900, the weight of target 900 can vary. For example, target 900 can weigh from two (2 lbs.) to thirty (30 lbs.) pounds. Preferably, target 900 weighs eighteen (18) pounds. In one such embodiment, the target stand system (including the target and target stand) can weigh upwards of forty pounds (40 lbs.). In such a case, the combined weight of the target and target stand in a given embodiment can range from three pounds (3 lbs.) to fifty pounds (50 lbs.). An exemplary example can have a combined weight of twenty pounds (20 lbs.). The target 900 may be shaped to resemble an animal (not shown). This resemblance to an animal may aid target shooters practice because it provides a realistic target 900 shape. For instance, the target 900 may resemble a deer buck.

Regardless of the size and/or shape of the target 900, the target may comprise a keyhole 918. The keyhole 918 shape may be pyramid or cylindrical. The keyhole 918 may be placed in the center of the target 900 or it may be placed according to the specific design of the target 900. The keyhole 918, in some embodiments, is shaped to match the shape of the key 700. For example, if the key 700 is in a tapered cylindrical configuration (FIGS. 1, 7A), the keyhole 918 may be designed such that the key fits flush within the keyhole 918 (FIG. 9B). In other words, the keyhole may be shaped to match the key 700 (and overall target insert 400) such that minimal space exists within the keyhole after inserting the target insert 400.

The set screw 120 may hold tube slot 104 in-place, thus restricting rotation of the target 900 and key 700 when struck by a given projectile. Because the target 900 and the key 700 may be made from high friction materials (foam and/or elastomer), when the target 900 receives a projectile, the friction of the two components aids in maintaining the position and orientation of the target 900. For instance, if the target 900 receives an arrow on the corner of a cubic target 900, the friction between the key 700 and the target 900 may, among other things, (i) prevent the target 900 from spinning about the target insert 400 and (ii) prevent the target 900 from being knocked off the top of the target insert 400.

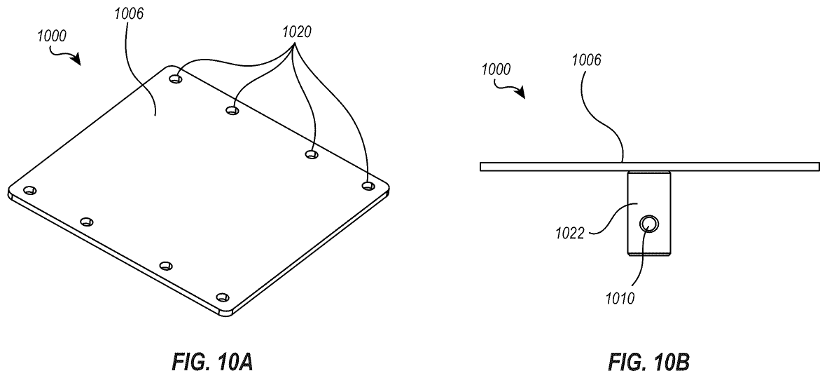

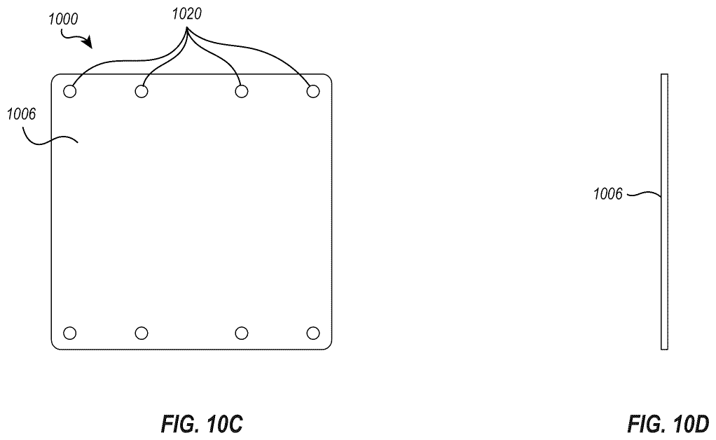

FIGS. 10A-10C illustrate a perspective view, a side view, and a top view, respectively, of an example target mount 1000 for a multi-legged target system 100. In some embodiments, the target system 100 may use a target mount 1000 instead of a target insert 400 for securing a target 900 to the target system 100. The target mount 1000 may comprise a mounting plate 1006, securing holes 1020, a side hole 1010, and a mounting connector 1022.

The mounting connector 1022 may be configured similarly to the tube 500 or may be an embodiment of tube 500. However, the mounting connector 1022 may be secured to the bottom of the mounting plate 1006 via a weld or fastener(s). The set screw 120 may also hold tube slot 104 in place, limiting its movement through base 118. The side hole 1010 serves a similar function as and, in some embodiments, has a similar structure to the side hole 510. Side hole 1010 may be aligned with the frame hole 116 of the tube slot 104 to allow a pin (or other fastener) to secure the target mount 1000 to the frame 112.

Rope, cords, or other fasteners may be used in conjunction with the securing holes 1020 in order to secure the target 900 to the target mount 1000. The holes 1020 may be D rings to attach a fastener, such as a rope or strap. For instance, a target that does not have a keyhole 918 may be used with target system 100 by using the target mount 1000 and its securing holes 1020. The mounting plate 1006 may be of nearly any shape or size (e.g., square, circular, star, oval, etc.). The securing holes 1020 may be positioned nearly anywhere on the mounting plate 1006 such that a fastener may be used to secure a target 900.

FIG. 10D illustrates a side view of an example mount platform 1006 for a multi-legged target stand. The mounting plate 1006 may be about eight inches by eight inches (8″×8″) when in a square configuration. Further, the mounting plate 1006 may be about one-fifth inches (⅕″) deep.

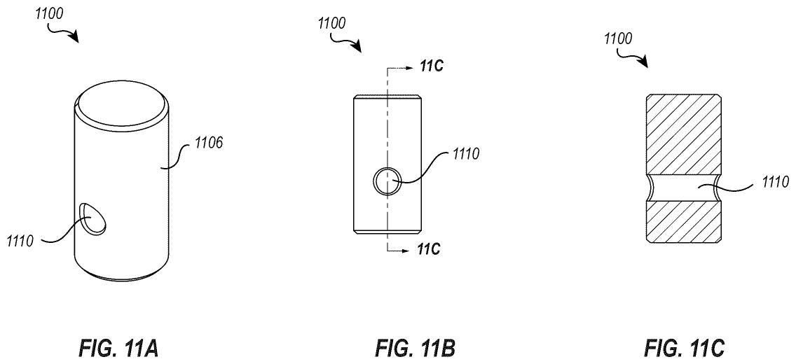

FIGS. 11A-11C illustrate a perspective view, a side view, and a cross-sectional view, respectively, of an example mount connector for a multi-legged target stand. As discussed above, the mounting connector 1100 may be similar in structure to the tube 500. In some embodiments, the mounting connector 1100 may comprise a side hole 1110 that, when inserted into the tube slot 104 may be aligned with the frame hole 116 to and secured to the frame via fastener. The mounting connector 1100 may be about two inches (2″) tall and one inch (1″) wide. The side hole 1110 may be bored through the mounting connector 1100 in a circular manner. The side hole 1110 may be about one-third inches in diameter (⅓″).

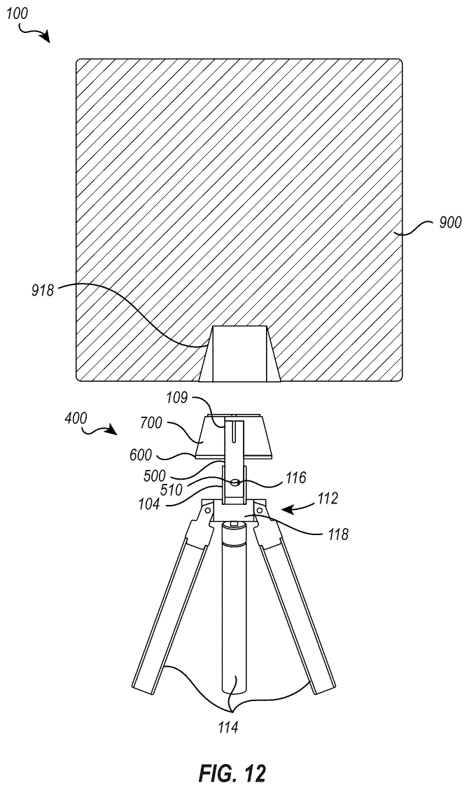

FIG. 12 illustrates a cross-sectional-exploded view of an example target system 100 with a target 900, target insert 400, and frame 112. It should be appreciated that the target system 100 may be made of many different materials (unless otherwise mentioned above). The components that are not foam and/or elastomer may be powder-coated steel, steel, stainless steel, aluminum, durable plastic, or many other structure-maintaining materials.

In sum, the disclosed target system addresses many of the drawbacks of conventional target systems. The disclosed target system, for example, provides at least the following benefits to target shooters: it raises the target to a typical shooting height where hunters and competitors would realistically aim and keeps the target away from possible projectile-breaking objects (e.g., boulders or rocks); it allows for quick, efficient, and portable set-up/take-down of the frame and target such that target shooters may set-up/take-down the target in the wild or on personal property with case; and it is capable of operation in rugged terrain where conventional target systems would not be operable.

While certain embodiments of the present disclosure have been described in detail, with reference to specific configurations, parameters, components, elements, etcetera, the descriptions are illustrative and are not to be construed as limiting the scope of the claimed invention.

Furthermore, it should be understood that for any given element of component of a described embodiment, any of the possible alternatives listed for that element or component may generally be used individually or in combination with one another, unless implicitly or explicitly stated otherwise.

In addition, unless otherwise indicated, numbers expressing quantities, constituents, distances, or other measurements used in the specification and claims are to be understood as optionally being modified by the term “about” or its synonyms. When the terms “about,” “approximately,” “substantially,” or the like are used in conjunction with a stated amount, value, or condition, it may be taken to mean an amount, value or condition that deviates by less than 20%, less than 10%, less than 5%, or less than 1% of the stated amount, value, or condition. At the very least, and not as an attempt to limit the application of the doctrine of equivalents to the scope of the claims, each numerical parameter should be construed in light of the number of reported significant digits and by applying ordinary rounding techniques.

The purpose of mentioning specific measurements in this disclosure is to provide clarity and facilitate understanding of the various aspects of the target system 100. However, it should be appreciated that the true essence of the target system 100 lies in the inventive concepts, methods, and functionality described herein, rather than in any particular numerical value.

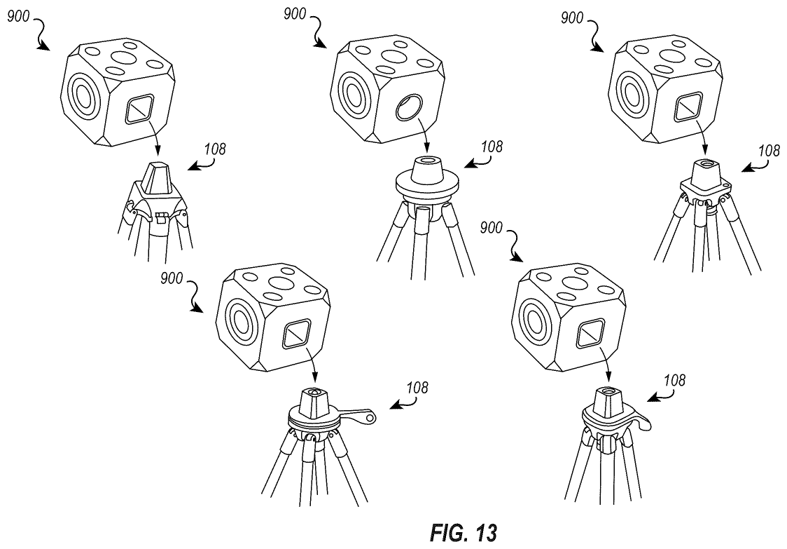

FIGS. 13 illustrates various conceptual renderings of a target stand, target, and key in accordance with embodiments of the present invention. For example, FIG. 13 illustrates various schematics in which a target is placed over keys of various shapes.

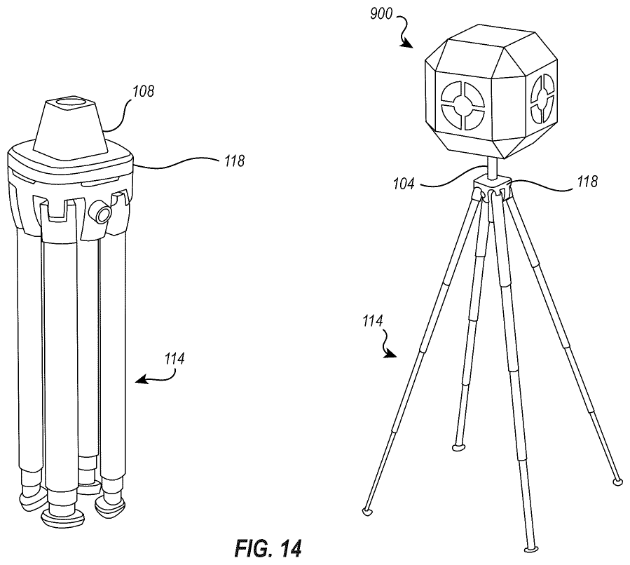

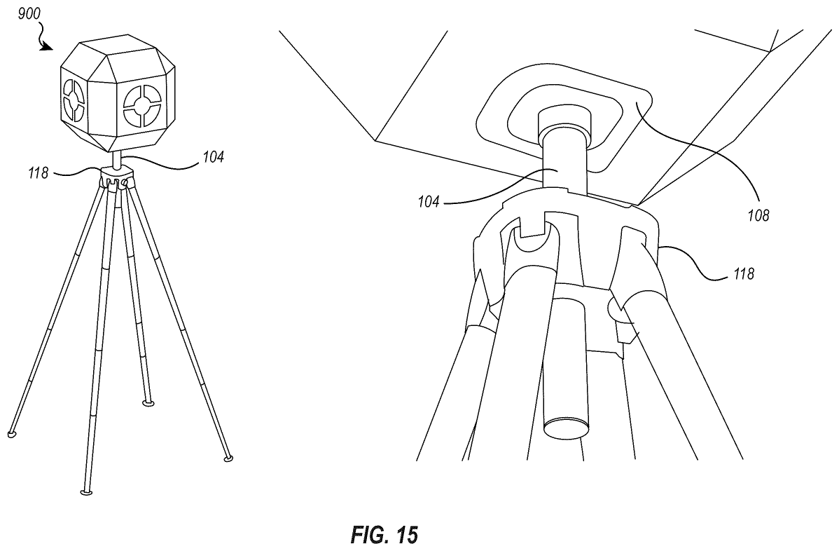

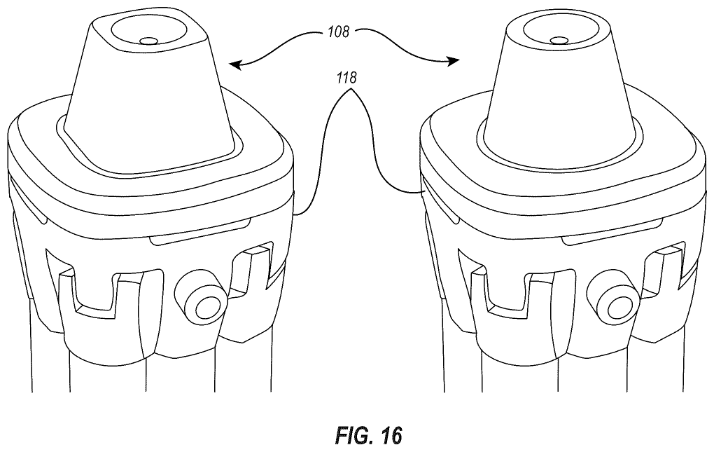

Meanwhile, FIGS. 14-15 illustrate disassembled and assembled views of another embodiment of the stabilizing legs and attached target. FIG. 14 illustrates an embodiment wherein tube 500 is not used, rather tube slot 104 is extendable through base 118. Tube slot 104 (also referred to as an extendable tube in an embodiment) can be reciprocally recessed within base 118 to allow a user to have further adjustments of target 900. In such cases, tube slot 104 may be directly connected to key 108 and fastened together with threading, slotting, fasteners, clamps, plates, or otherwise. Tube slot 104 may be used to raise or lower target 900, rotate target 900, or can be used when stowing the target stand system, as seen in the left most illustration of FIG. 14. A previously described tube slot 104 can vary in length, and as such, it can be relative to base 188 anywhere along its base. In addition, FIG. 15 illustrates perspective top and bottom views of a target shooting stand. Furthermore, FIG. 16 illustrates various perspective views of a squared and rounded key positioned atop the stabilizing legs in accordance with implementations of the present invention.

With reference to the elements shown in FIGS. 13-16 or any of the foregoing Figures discussed herein, in one exemplary implementation, the target 900 may be any number or combination of dimensions, such as 10″-30″ tall by 10″-30″ wide, and 10″-30″ deep, such as 18″ tall by 16″wide×16″ deep. Moreover, the target may extend to a height of from 24″-60″ in height, such as 36″-42″ in height. One will appreciate, therefore, that the stand, with corresponding tube slot 104, legs 114, and key 108 can be manufactured to a wide range of dimensions in order to a wide range of sizes, shapes, and weights of targets 900. Hence, the shapes and number of components described or illustrated herein are exemplary only, and may be adjusted within the spirit and scope of the invention.

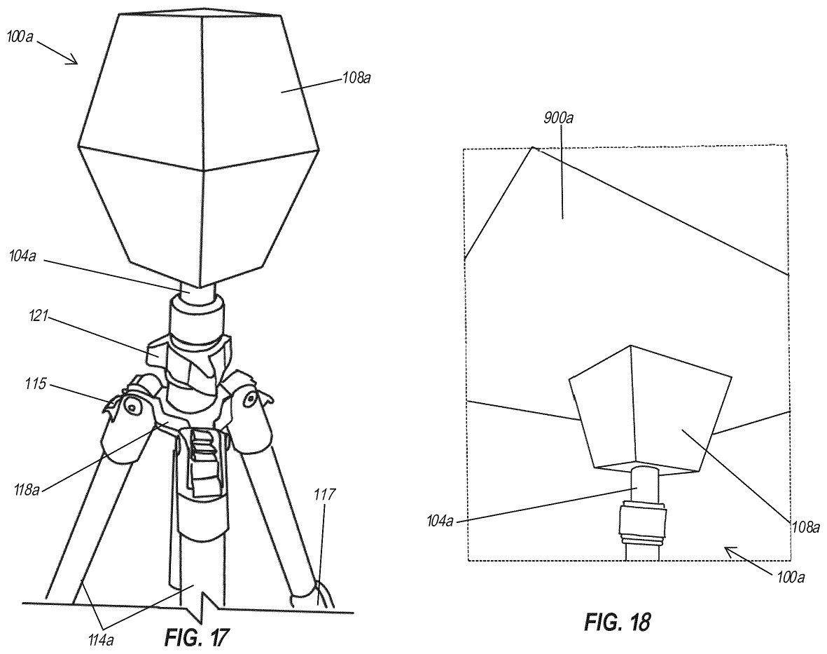

FIG. 17 illustrates a stabilized target stand of the present disclosure. Stabilized target stand 100a can include one or more stabilizing legs 114a, a base 118a, tube slot 104a, and key 108a. Stabilizing legs 114a can be telescoping legs having multiple segments. Stabilizing legs 114 can include one or more clamps 117 configured to secure the segments to a desired length. This means a user can adjust stabilizing legs 114a individually to adapt to uneven terrain. Stabilizing legs 114a can couple to base 118a by way of system 115. System 115 can be a ratch or teeth-latching mechanism allowing users to secure each leg 114a to a desired angle. Once set, system 115 can retain each leg 114a in the position set by the user. As in other embodiment, tube slot 104a can extend through back 118a. A user can extend tube slot 104a or retract tube slot 104a relative to base 118a to raise or lower a target 900a, shown in FIG. 18, coupled with key 108a. A user can also rotate locker 121 to secure tube slot 104a into a desired extended or retracted length. Locker 121 can be a threaded system that, when turned in one direction, causes locker 121 to tighten around tube slot 104a, and, when turned in the opposite direction, can cause the locker to loosen around tube slot 104a.

FIG. 17 also shows key 108a secured to tube slot 104a. Tube slot 104a defines one or more holes along its length. A manufacturer can then form key 108a around tube slot 104a and allow key 108a to form at least partially into the one or more holes along the length of tube slot 104a. This advantageously limits the ability of key 108a to rotate around tube slot 104a. As illustrated in FIG. 17, key 108a can have the shape of two partial rectangular pyramids connected at their bases. This shape and formation can be more rigid and advantageously allows a target to be secured in a more secure and stable position when impacted.

FIG. 18 illustrates a stabilized target stand 100a interfacing with a target 900a using key 108a. A user can secure target 900a to key 108a by a friction fit.

Tube slots, tube, and stabilizing legs can be constructed from aluminum. The foam used in the keys of the present disclosure can have a density of 15 pounds per square foot. This high density can allow the foam to last longer and retain its structure after repeated use.

It will also be noted that, as used in this specification and the appended claims, the singular forms “a,” “an” and “the” do not exclude plural referents unless the context clearly dictates otherwise. Thus, for example, an embodiment referencing a singular referent (e.g., “widget”) may also include two or more such referents.

It will also be appreciated that embodiments described herein may include properties, features (e.g., ingredients, components, members, elements, parts, and/or portions) described in other embodiments described herein. Accordingly, the various features of a given embodiment can be combined with and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include such features.

### REFERENCE NUMERALS

100(a) target shooting stabilizing system
102 target insert
104(a) tube slot
106 plate
108(a) key
109 top pin
110 top plate
111 top hole
112 fame
114(a) stabilization legs
115 latch
116 frame hole
117 clamp
118(a) base
120 set screw
121 locker
400 target insert
404 tube
406 plate
408 top hole
410 side hole
500 tube
506 tube body
508 top hole
510 side hole
600 plate
606 plate body
614 plate hole
700 key
714 key body
716 key bore
800 top plate
806 top plate body
814 top plate hole
900(a) target
918 keyhole
1000 target mount
1006 mounting plate
1010 side hole
1020 securing holes
1022 mounting connector
1100 mounting connector
1106 mounting connector body
1110 side hole

I claim:

1. A target stand, comprising:
a base;
a tube slot selectively coupled to the base; and
a plurality of stabilization legs coupled to the base, wherein each stabilization leg is independently adjustable in height and angle with respect to an adjacent stabilization leg.

2. The target stand of claim 1, further comprising a target insert comprising:
a tube configured to be received by the tube slot;
a plate for supporting a target relative to the target insert; and
a key comprising a bore wherein the key is selectively secured to the tube with a top plate.

3. The target stand of claim 2, further comprising a target wherein the target comprises a keyhole configured to reciprocally recess with the key.

4. The target stand of claim 1, wherein the tube slot further comprises a key selectively secured to the tube slot with a top plate.

5. The target stand of claim 4, wherein the tube slot further comprises a plate for supporting a target.

6. The target stand of claim 1, wherein the tube slot is configured to extend through and secure within an aperture in the base.

7. The target stand of claim 6, wherein the tube slot is configured to raise a target eight inches (8″) relative to the base.

8. The target stand of claim 1, wherein the plurality of stabilization legs are configured to extend to sixty inches (60″).

9. The target stand of claim 1, wherein the target stand weighs two pounds (2 lbs.).

10. The target stand of claim 2, wherein the target stand and target comprise a combined weight of twenty pounds (20 lbs.).

11. The target stand of claim 1, further comprising a key, formed from a foam or elastomeric material.

12. The target insert of claim 2, wherein the tube slot includes a side hole for securing the target insert.

13. A target mount for use with the target stand of claim 1, comprising:
a mounting plate comprising a plurality of securing holes for securing a target to the mounting plate; and
a mount connector comprising a side hole for securing the target mount to the tube slot.

14. A stabilized target system comprising:
a base;
a tube slot selectively coupled to the base;
a key comprising a bore wherein the key is selectively secured to the tube slot with a top plate;
a target comprising a keyhole configured to reciprocally recess with the key; and
a plurality of stabilization legs coupled to the base, each of which being independently adjustable with respect to the other.

15. The stabilized target system of claim 14, further comprising a target insert comprising:
a tube configured to be received by the tube slot; and
a plate for supporting the target relative to the target insert;
wherein the key is first secured to the tube rather than the tube slot.

16. The stabilized target system of claim 14, further comprises an aperture disposed through the base, wherein the tube slot extends through the aperture.

17. The stabilized target system of claim 14, wherein the key is made from a foam or elastomeric material and configured to provide a friction fit when reciprocally recessed with the keyhole.

18. The stabilized target system of claim 16, further comprising a clamp configured to secure the tube slot inside the aperture.

19. The stabilized target system of claim 14, further comprising a set screw configured to secure the tube slot inside the aperture.

20. A method of assembling a stabilized target system, comprising:
providing a target stand comprising:
a base comprising an aperture;
a tube slot selectively coupled to the base, extending through and securing in the aperture; and
a plurality of stabilization legs coupled to the base, wherein each stabilization leg is independently adjustable in height and angle with respect to an adjacent stabilization leg;
extending the plurality of stabilizing legs over an area of uneven ground;
adjusting at least one of the plurality of legs to a first length that is different from a second length of another of the plurality of legs, such that the stabilized target system, without further support, is capable of remaining in position in response to an arrow or bullet projected at the target
inserting a target insert into the tube slot, the target insert comprises:
a tube for supporting sideways movement of the target, wherein the tube is positioned adjacent to the target insert;
a plate for supporting the target relative to the target insert;
a key for facilitating the placement of the target adjacent the target insert; and
a top plate for securing the tube and the key; and
recessing a target, comprising a keyhole, onto the key by means of the keyhole; and
adjusting the tube slot relative to the base to facilitate further adjustments to the targets position.
